(19) United States
(12) Patent Application Publication
(10) Pub. No.: US 2003/0122966 A1
(43) Pub. Date: Jul. 3, 2003

(54) System and method for meta data distribution to customize media content playback

(75) Inventors: Michael J. Markman, Kirkland, WA (US); Kory D. Christensen, Kaysville, UT (US)

Correspondence Address: STOEL RIVES LLP, One Utah Center, Suite 1100, 201 South Main Street, Salt Lake City, UT, 84111, US

(73) Assignee: Digeo, Inc., Kirkland, WA

(21) Appl. No.: 10/328,940

(22) Filed: Dec. 24, 2002

Related U.S. Application Data
(63) Continuation-in-part of application No. 10/010,736, filed on Dec. 6, 2001.

(51) Int. Cl. H04N 7/173; H04N 7/16; H04N 5/445; G09G 5/00

(52) U.S. Cl. 348/563; 725/136; 725/112; 345/723

(57) ABSTRACT

A reviewer edits a media program stored in digital form. Such “editing” does not directly change the media program; rather, editing information is stored in a separate meta data file. The reviewer can be a person or an automated system. The meta data can include supplemental content, indicia defining highlight segments, skipped-over segments, content categorization, etc. The meta data files can be distributed to other users via various networks, or manually, including a decentralized, peer-to-peer network or a centralized, client-server network.

### RELATED APPLICATIONS

This application is a continuation-in-part of U.S. patent application Ser. No. 10/010,736, filed Dec. 6, 2001, for “Method and System for Distributing Personalized Editions of Media Programs Using Bookmarks,” with inventors Robert E. Novak, James K. Okamoto and Kory D. Christensen, which application is incorporated herein by reference in its entirety.

### BACKGROUND

1. Field of the Invention

The present invention relates generally to multimedia, for example television programming, and more specifically to creating, distributing and using meta data for customizing playback of media content programs, for example in a home media center, without distributing a modified copy of the program.

2. Description of Related Background Art

In recent years, the distribution of audio and video programs in a digital format has witnessed a tremendous increase in popularity. For example, compact discs (CDs) and digital versatile discs (DVDs) are now ubiquitous in the industry. Moreover, personal video recorders (PVRs), which digitally record broadcast television programs, are now replacing analog video cassette recorders (VCRs) in many households.

Digital editing of media programs by consumers is also becoming more popular. Today, consumers may digitally record and edit a television program to create a personalized edition that is free of commercials or that only contains highlights.

Users may desire to share these personalized editions with their friends or relatives. Unfortunately, a number of obstacles limit a consumer's ability to share an edited version of a media program with other people. First, storing media content, particularly video, in a digital format consumes a large amount of storage space. For example, a two-hour movie may easily include more data than may be conveniently stored on a CD-ROM. Likewise, transmitting media content via a network, such as the Internet, consumes a great deal of bandwidth. Consequently, transmitting an edited version of a program to a friend may be both slow and expensive.

Second, sharing personalized editions of media programs may violate copyright laws. In the United States, the Digital Millennium Copyright Act (DMCA) imposes limitations on sharing protected content in a digital format. Moreover, recent decisions involving Napster and other companies have highlighted the copyright issues raised in file sharing.

Thus, it would be an advancement in the art to provide a technique for distributing personalized editions of media programs that does not consume excessive bandwidth or violate applicable copyright laws.

### BRIEF DESCRIPTION OF THE DRAWINGS

FIG. 1 is a block diagram of a system for distributing media signals to subscribers;

FIG. 2 is a block diagram of a set top box (STB);

FIG. 3 is a block diagram of a home entertainment system including a media center and a number of media center extensions (MCXs) for supporting multiple televisions within a household, office, campus or other networked environment;

FIG. 4 is a block diagram of the home entertainment system of FIG. 3 showing details of a media center and MCX;

FIG. 5 is a dataflow diagram of the home entertainment system of FIG. 3;

FIG. 6 is a block diagram illustrating a simple example of creating and sharing meta data to effectively customize the playback of a stored media content file.

FIG. 7 is a simplified diagram illustrating an editing device user interface and a method of using the editing device to create meta data including bookmarks pointing to specific locations or scenes within a media program.

FIG. 8 is a block diagram showing selected aspects of an editing device and a playback device employing meta data for playback control.

FIG. 9 is a block diagram showing selected aspects of a pair of media centers sharing meta data.

FIG. 10 illustrates a client-server implementation for distributing meta data to multiple subscribers.

FIG. 11 is a simplified flow diagram of a method of using meta data in accordance with the present invention.

### DETAILED DESCRIPTION

Reference is now made to the figures in which like reference numerals refer to like or similar elements. For clarity, the first digit or digits of a reference numeral indicates the figure number in which the corresponding element is introduced.

Throughout the specification, reference to “one embodiment” or “an embodiment” means that a particular described feature, structure, or characteristic is included in at least one embodiment of the present invention. Thus, appearances of the phrases “in one embodiment” or “in an embodiment” in various places throughout this specification are not necessarily all referring to the same embodiment.

As used herein, the term “coupled” refers not only to components that are directly connected, but also to components that are connected via one or more other components. Hence, the term “coupled” may also refer to components that are in communication with one another, although no physical connection may exist.

In the following description, numerous specific details, such as examples of programming, software modules, user selections, network transactions, database queries, database structures, etc., are provided for a thorough understanding of the embodiments of the invention. Those skilled in the art will recognize, however, that the invention can be practiced without one or more of the specific details, or with other methods, components, materials, etc. In other instances, well-known structures, materials, or operations are not shown or not described in detail to avoid obscuring aspects of the invention. Furthermore, the described features, structures, or characteristics may be combined in any suitable manner in one or more embodiments.

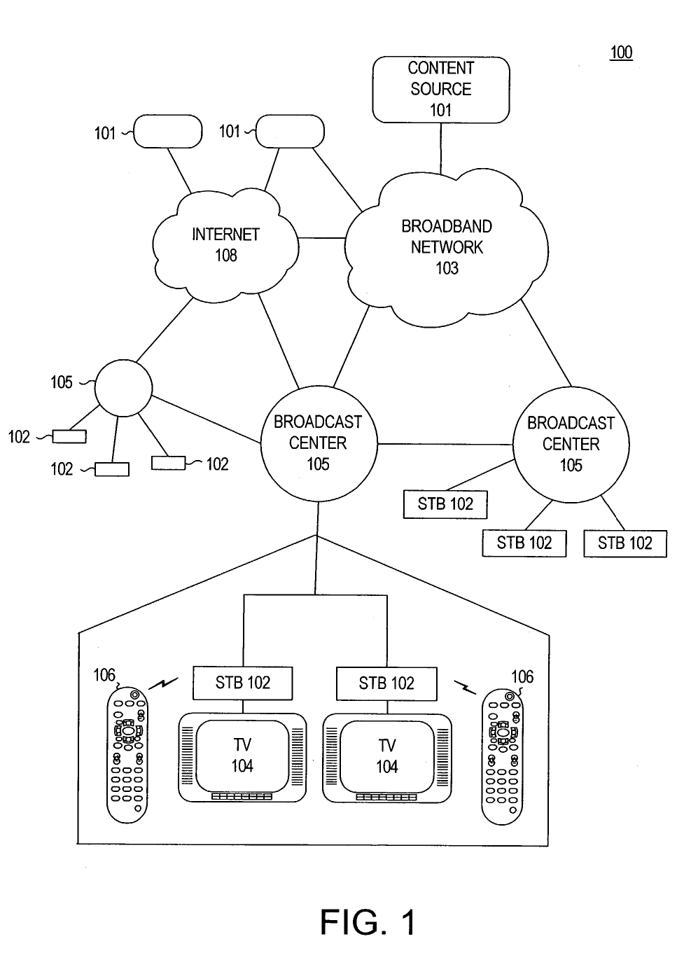

As illustrated in FIG. 1, a typical system 100 for distributing media signals to subscribers includes one or more content sources 101 linked to plurality of set top boxes (STBs) 102 by a broadband network 103. As used herein, the term “media signals” should be broadly construed to include video and/or audio content, pictures, animations, text, software programs, etc. As such, content sources 101 may include television networks, websites, video servers, music servers, software archives, databases, and the like.

An STB 102 receives media signals from the content source(s) 101 via the network 103 and displays the same on a television (TV) 104 or similar display device. As its name implies, an STB 102 is typically located on or in close proximity to the TV 104. Conventionally, each TV 104 must have its own STB 102 in order to receive and display media signals.

The broadband network 103 is typically a cable TV network or a direct broadcast satellite (DBS) network, although other networks are possible. The STBs 102 are coupled to the network 103 directly or through one or more broadcast centers 105.

In the context of a cable TV network, a broadcast center 105 is referred to as a “head-end”, i.e., a centrally-located facility within a community in which TV programming is received from a local cable TV satellite downlink or other source and packaged for transmission to subscriber homes. A broadcast center 105 may also be embodied as a satellite broadcast center within a DBS network.

Broadcast centers 105 may be directly coupled to one another or connected through the broadband network 103. In some cases, broadcast centers 105 may be connected through other networks, one particular example of which is the Internet 108. Communication over the Internet 108 is accomplished using TCP/IP (Transmission Control Protocol/Internet Protocol) and other standard protocols.

For each STB 102, a remote control 106 is generally provided for convenient remote operation of the STB 102 and the TV 104. The remote control 106 may use infrared (IR), radio frequency (RF), or other wireless technologies to transmit control signals to the STB 102 and the TV 104.

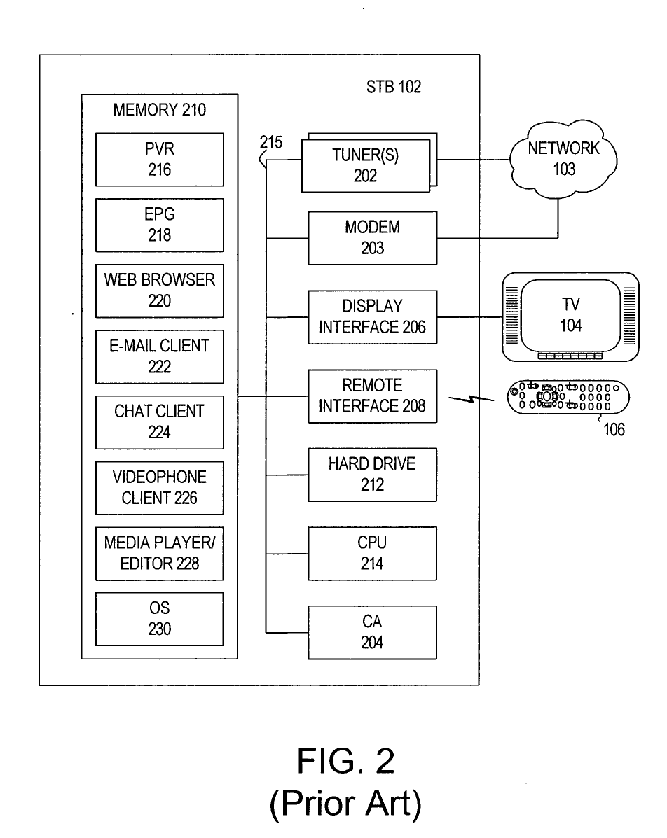

FIG. 2 is a detailed block diagram of a standard STB 102, such as a Motorola™ DCT5200™. As depicted, the STB 102 includes at least one tuner 202 for selectively receiving media signals from the broadband network 103 on different channels or frequencies. Various analog tuners 202 are available, such as the Broadcom™ BCM 3415™.

Increasingly, TV broadcasts are being digitally encoded and multiplexed to maximize bandwidth usage. For instance, “digital” cable systems utilize MPEG (Moving Pictures Experts Group) compression to provide subscribers with many more channels than would be possible using analog techniques. Accordingly, a “digital” tuner 202 may include circuitry for selectively demodulating, demultiplexing, and decoding such content.

The STB 102 may also include a modem 203 for communication with the Internet 108 and/or the broadband network 103. The modem 203 may be embodied as a Motorola™ cable modem, which conforms, for instance, to the Data Over Cable Service Interface Specification (DOCSIS). Alternatively, the modem 203 may be adapted to communicate with a Public Switched Telephone Network (PSTN).

The STB 102 may also include a conditional access (CA) device 204 for decrypting media signals for premium and pay-per-view (PPV) channels or services (e.g., HBO™, Showtime™, OnDemand™). A CA device 204 makes use of both scrambling and encryption technologies to prevent reception of a signal by unauthorized STBs 102. In one technique, encrypted messages, known as Entitlement Control Message (ECM) and Entitlement Management Message (EMM), are used. CA devices 204 and techniques are known in the art and will not be discussed in greater detail.

The STB 102 further includes a display interface 206 for rendering media signals on an attached display device, such as a TV 104. A display interface 206 typically includes a graphical processor, a memory (frame buffer), a digital-to-analog converter (DAC), and various other supporting hardware for outputting media signals capable of being displayed by an analog or digital TV 104. A variety of display interfaces 206 are known, such as the ATI™ Xilleon™ 215s or Broadcom™ BCM7031™.

The STB 102 also includes a remote interface 208 for receiving and decoding control signals sent by a remote control 106. As noted, various wireless techniques may be used, such as infrared (IR), radio frequency (RF), or the like. In one configuration, the remote interface 208 is embodied as an ATMEL™ Mega161™ IR microcontroller.

Typically, the STB 102 includes a memory 210 comprising a combination of one or more standard RAM, ROM, FLASH, EEPROM or other memory devices now known or later developed. The memory 210 is used for storing program code, user settings, and other data. Similarly, the STB 102 includes a hard drive 212 or other mass storage unit for storing media streams, applications, databases, etc.

The STB 102 also typically includes a CPU 214 for controlling the operation of the STB 102, including the other components thereof, which are coupled to the CPU 214 via a bus 215. The CPU 214 may be embodied as a microprocessor, microcontroller, digital signal processor (DSP), or other device known in the art. The CPU 214 performs logical and arithmetic operations based on program code stored within the memory 210.

To enable interactive television (ITV) functionality, the memory 210 of the STB 102 generally includes a number of software modules, objects, or applications. Of course, any of the described modules may be implemented using various combinations of software, hardware, and/or firmware.

For instance, the memory 210 may include a personal video recording (PVR) module 216 to facilitate digital recording of media signals. The popularity of PVR systems, such as TiVo™ and ReplayTV™, has tremendously increased in recent years. PVR systems provide a wide variety of desirable functions, such as scheduled recording of TV broadcasts for time-shifting purposes, pausing (buffering) of live TV, instant replays, and the like.

The memory 210 may also include an EPG (Electronic Programming Guide) module 218 that provides a subscriber with a view of upcoming television programming. The EPG module 218 may display programming information in various formats, such as a timeline, grid, or the like, allowing a subscriber to easily view upcoming or current programming. In addition, the EPG module 218 may interact with the PVR module 216 to allow a subscriber to select programs for recording directly from an EPG listing. The EPG module 218 typically obtains programming information from the network 103 using the modem 203.

The memory 210 may further include a web browser 220, such as a version of Microsoft Internet Explorer™, to facilitate access to web content within the Internet 108. Similarly, the memory 210 may include an e-mail client 222, such as Microsoft Outlook™, a chat (instant messaging) client 224, such as MSN Messenger™, a videophone client 226, such as Microsoft Netmeeting™, and a media player/editor 228, such as Windows Media Player™ and/or Windows Movie Maker™. The memory preferably also includes a peer-to-peer (P/P) file sharing application, e.g., one based on the gnutella protocol.

Furthermore, the memory 210 may include an operating system (OS) 230, such as Windows XP™, Windows CE™, or Linux™ for managing the other modules described above. Middleware, such as Liberate™, may also be provided to facilitate interaction between the OS 230 and the described modules.

Unfortunately, advanced STBs 102 of the type depicted in FIG. 2 are relatively expensive. Moreover, as previously noted, each TV 104 must have a separate STB 102 for ITV access. Thus, the cost of enabling ITV features for multiple TVs 104 within a home can be prohibitive for many subscribers.

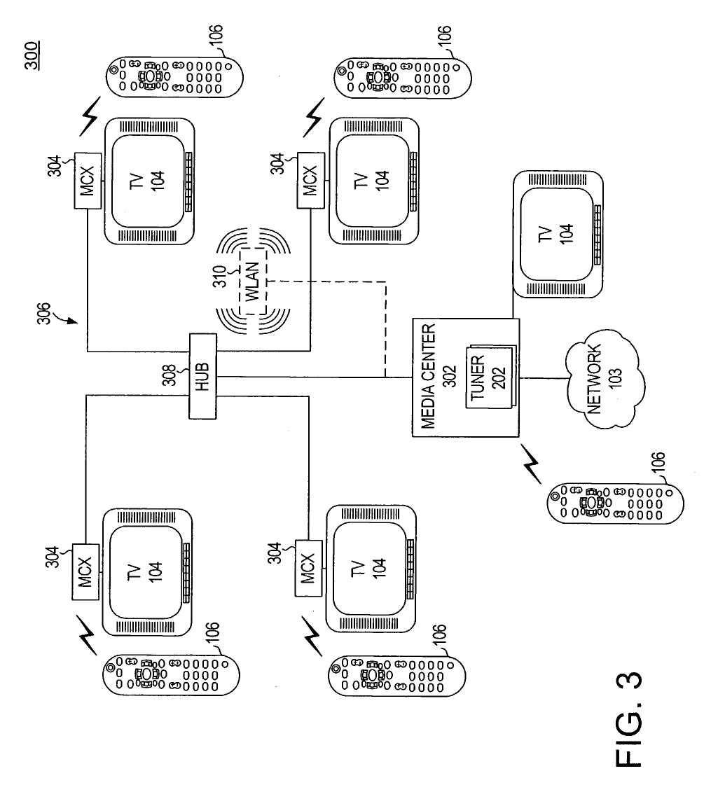

FIG. 3 is a block diagram of a home entertainment system 300 that provides ITV functionality to multiple TVs 104 without the need for several expensive STBs 102. As illustrated, the system 300 includes media center 302. In many respects, the media center 302 is similar to the STB 102 of FIG. 2, and may be embodied as an STB 102 with various modifications, as described below. The media center 302 may also be embodied as a home personal computer (PC) with suitable hardware and software modifications.

The system 300 also includes a number of relatively inexpensive media center extensions (MCXs) 304. Typically, one MCX 304 is provided for each TV 104 in the home for which ITV features are desired. An MCX 304 may be coupled to a TV 104 using standard audio/video connections.

Each MCX 304 is communicatively coupled to the media center 302 via a home network 306. The home network 306 may be embodied as a 10/100 Mbps Ethernet (including a hub 308), an IEEE 802.11 wireless network (including a wireless LAN station 310), a HomePNA™ network, a HomeCNA™ network, a HomePlug™ network, an IEEE 1394 network, a Bluetooth™ network, or any other wired or wireless network. Many homes already include a suitable home network 306.

As described in greater detail below, the media center 302 functions as a centralized reception and distribution center for media signals (e.g., TV signals) within a home. The media center 302 receives media signals from the broadband network 103 using one or more tuners 202. The media center 302 then encodes the media signals into media streams (e.g., MPEG streams) and distributes the media streams to the appropriate MCXs 304.

Each MCX 304 decodes a media stream received from the home network 306 and renders the stream on an associated TV 104. Also, each MCX 304 receives user commands from a remote control 106 or other input device, which the MCX 304 then relays to the media center 302. The commands, for example, may instruct one of the tuners 202 of the media center 302 to tune to a different media signal, changing what is displayed on a TV 104.

The system 300 is scalable to support any number of home TVs 104 by adding MCXs 304. Because the MCXs 304 are relatively inexpensive, providing ITV functionality to a new TV 104 is not a prohibitive investment for either a subscriber or a cable or satellite operator.

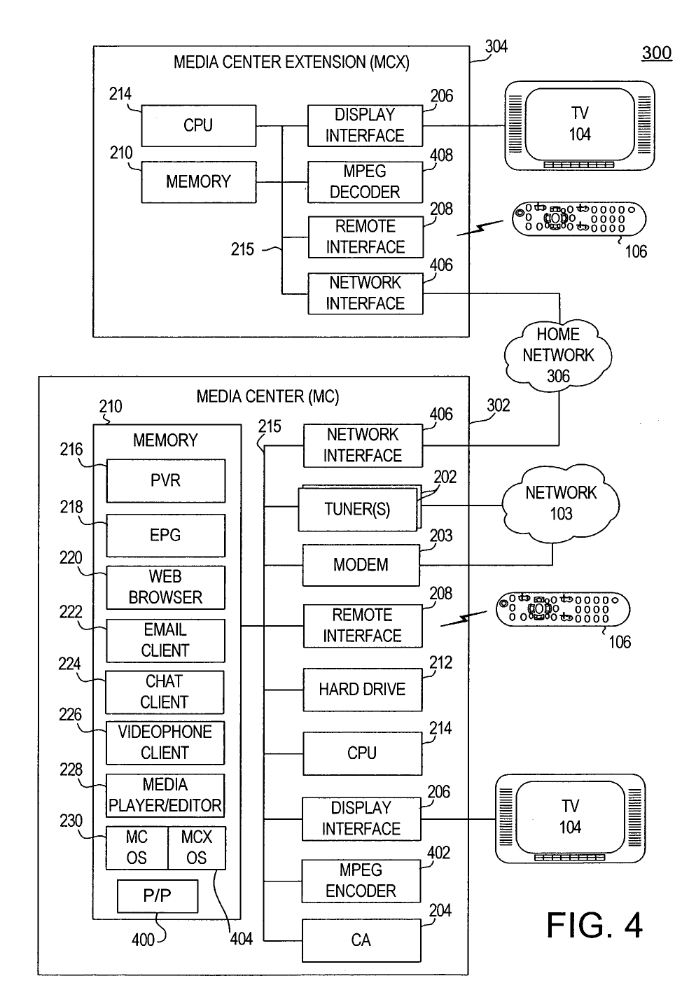

FIG. 4 is a more detailed block diagram of the home entertainment system 300 according to an embodiment of the invention. As depicted, the media center 302 may include various components in common with an STB 102. For instance, a media center 302 may include a modem 203, CA device 204, display interface 206, remote interface 208, CPU 214, and memory 210. As such, the media center 302 may directly function as an STB 102 to provide ITV functionality for one TV 104 in a household.

Of course, the precise selection and configuration of components of the media center 302 may vary from those of the STB 102. For clarity, however, components having similar functions are indicated herein by like reference numbers even though minor differences may exist between instantiations.

As described above, the media center 302 may include multiple tuners 202. While only two tuners 202 are depicted, any number of tuners 202 are contemplated within the scope of the invention. In one embodiment, a tuner 202 may be a modular device, such as an add-in card, which may be installed within the media center 302 by a user or a technician. For instance, the media center 302 may include a number of Peripheral Component Interconnect (PCI) bus slots, which may be configured to receive one or more add-in tuner cards.

As illustrated, the media center 302 may also include at least one MPEG encoder 402, such as an NEC™ μPD61xx encoder, for encoding or transforming media signals received from the network 103 into media streams for transmission to the MCXs 304. While MPEG-2 is used in one embodiment, a variety of other encoding schemes may be used within the scope of the invention, such as MPEG-1, MPEG-4, JPEG, JPEG-LS, H.261, and H.263. Accordingly, the invention should not be construed as being limited to MPEG-2 encoding. In certain embodiments, multiple encoders 402 may be provided, particularly where more than two tuners 202 are being used.

The media center 302 may additionally include a network interface 406 for communicating with a number of MCXs 304 over the home network 306. The configuration of the network interface 406 will vary depending on the type of home network 306. For instance, the network interface 406 may be embodied as an 10/100 Mbps Ethernet adapter, 802.11b wireless adapter, an IEEE 1394 (“firewire”) adapter, or so forth.

As illustrated, the memory 210 of the media center 302 includes various software modules similar to those of the STB 102. For instance, the memory 210 of the media center 302 may include a PVR module 216, an EPG module 218, a web browser 220, an e-mail client 222, a chat client 224, a videophone client 226, and a media player/editor 228. As previously indicated, the functionality of any of the described modules may be implemented using any suitable combination of software, hardware, and/or firmware.

In addition to an operating system (OS) 230, such as Windows XP™, the memory 210 of the media center 302 may include an OS 404 for the MCXs 304, such as Linux™ or Windows CE™, as described in greater detail below.

In the depicted embodiment, the MCX 304 also includes certain components in common with an STB 102. For instance, the MCX 304 may include a display interface 206, a remote interface 208, a memory 210, a CPU 214, a bus 215, etc.

In addition, the MCX 304 may include an MPEG decoder 408 for decoding media streams received from the media center 302. The MPEG decoder 408 may be embodied as a separate MPEG decoding chip, as a software codec, or as part of a display interface 206, such as an ATI™ Xilleon™ 215s. A variety of MPEG decoding solutions are known in the art.

The MCX 304 may further include a network interface 406 for receiving media streams from the media center 302 through the home network 306. In certain configurations, the MCX 304 may use the network interface 406 to boot (i.e., load the MCX OS 404 into memory 210) from a copy stored within the media center 302. For instance, the network interface 406 of the MCX 304 may be compatible with the 3Com™ DynamicAccess™ managed PC boot agent or other network boot service. This eliminates the need for the MCX 304 to locally store the MCX OS 404 within a flash memory or hard drive 212, reducing the cost of the MCX 304.

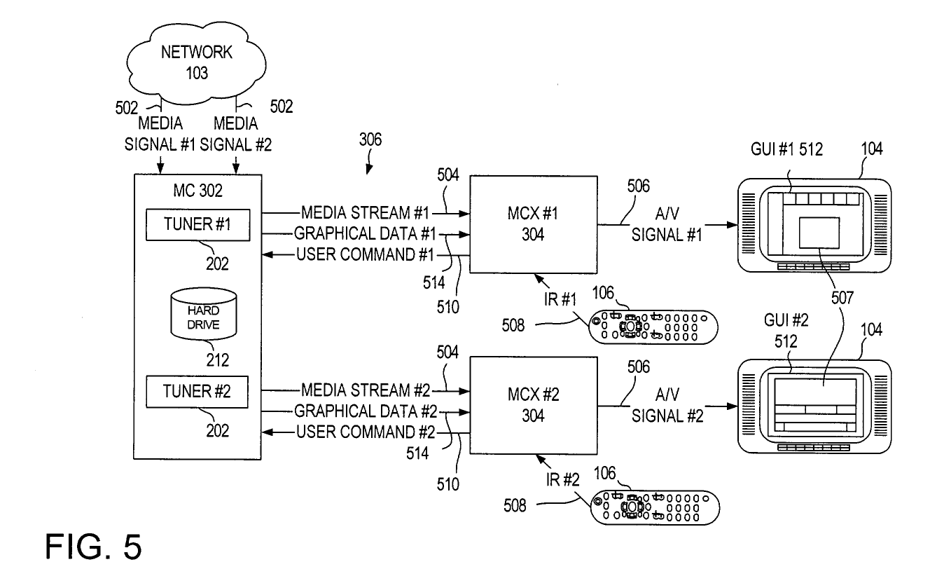

FIG. 5 depicts the flow of data between a media center 302 and two MCXs 304. Those of skill in the art will recognize, however, that any number of MCXs 304 may be connected to the media center 302 via the home network 306.

As illustrated, the media center 302 receives a number of media signals 502 from the network 103. The media signals 502 may be analog TV signals, multiplexed digital cable or satellite TV signals, video-on-demand (VoD) signals, or other transmissions. Typically, a media center 302 receives hundreds of multiplexed signals 502 from the network 103 at the same time.

In general, each tuner 202 within the media center 302 may tune to one of the media signals 502. While components exist that may tune to multiple signals 502, such components should be properly described as including multiple tuners 202.

At least one encoder 402 within the media center 302 encodes the tuned media signals 502 into media streams 504 (e.g., MPEG streams) suitable for transmission over the home network 306. As noted, the media streams 504 may use other encoding schemes known in the art.

In certain configurations, the media streams 504 are buffered or stored within a hard drive 212 or other storage device. Once stored, the media stream 504 may be used or manipulated in various ways. For instance, the media stream 504 may be edited using the media player/editor 228, sent to another subscriber using the videophone client 226 or the e-mail client 222, indexed for subsequent playback by the PVR module 216, etc.

As described below, each media stream 504 is typically sent over the home network 306 to an MCX 304 at which a user has indicated a desire to watch the corresponding media signal 502 (e.g., TV channel). In some cases, a media stream 504 may be sent to multiple MCXs 304 if the same media signal 502 is to be watched on multiple TVs 104.

The receiving MCX 304 decodes the media stream 504 and renders the stream into an A/V signal 506 for display in a video window 507 on the TV 104. The video window 507 may include all or part of the TV screen. Various types of A/V connections may be used for transporting the A/V signal 506 from the MCX 304 to the TV 104, e.g., composite video, s-video, component video, stereo audio, optical/coaxial digital audio, radio frequency (RF), etc.

As an example of the foregoing, suppose the media center 302 receives two media signals 502, e.g., media signal #1 and media signal #2. Media signal #1 may be received by tuner #1, while media signal #2 may be received by tuner #2, as determined by users at MCX #1 and MCX #2, respectively.

In one configuration, media signal #1 is encoded into media stream #1, which is sent through the home network 306 to MCX #1. Similarly, media signal #2 is encoded into media stream #2, which is sent through the home network 306 to MCX #2. Within MCX #1, media stream #1 is decoded and rendered into A/V signal #1, which is displayed on TV #1. Likewise, within MCX #2, media stream #2 is decoded and rendered into AN signal #2 for display on TV #2.

One function of an MCX 304 is to allow users to interact with the media center 302 from TVs 104 located throughout the home. For instance, a user may specify which media signal 502 he or she desires to watch on a TV 104. To accomplish this, the subscriber activates a button on the remote control 106. For instance, the subscriber may press a “channel up” or “channel down” button.

The remote control 106 sends a corresponding IR command 508 (e.g., IR #1) to the MCX 304 (e.g., MCX #1). Of course, other wireless transmission techniques are possible, such as RF (radio frequency).

In one configuration, the receiving MCX 304 relays a user command 510 (e.g., user command #1) to the media center 302 via the home network 306. The user command 510 may instruct the media center 302 to tune one of its tuners 202 (e.g., tuner #1) to a particular media signal 502 and direct the corresponding media stream 504 to the requesting MCX 304 (e.g., MCX #1). The user command 510 may be any suitable type of message or data structure for conveying information about the IR command 508 to the media center 302.

As another example, a user of MCX #2 may press a button on the remote control 106 for playing back a media stream 504 selectively buffered within the hard drive 212 by the PVR module 216. As before, an IR command 508 (e.g., IR #2) is sent to the MCX 304, which is relayed as a user command 510 (e.g., user command #2) to the media center 302. The media center 302 retrieves the selected media stream 504 from the hard drive 212 and transports the stream 504 through the home network 306 to MCX #2, where it is decoded and rendered in the video window 507.

The media center 302 is also responsible, in one embodiment, for generating a Graphical User Interface (GUI) 512 on each TV 104. To accomplish this, the media center 302 sends graphical data 514 to each MCX 304, which are used by each display interface 206 to generate a GUI 512. As depicted, the TV 104 may display the GUI 512 simultaneously with the video window 507, although either the GUI 512 or the video window 507 may be exclusively displayed. Both the GUI 512 and the video window 507 are included in the A/V signal 506.

The graphical data 514 may be embodied, for instance, as low-level VGA (Video Graphics Array) commands which may be directly processed by circuitry within the display interface 206. Alternatively, the graphical data 514 may be graphical primitives understood by a thin-client module (not shown) within the MCX 304. In still other embodiments, the graphical data 514 may include higher-level data objects, such as graphics and text.

The GUIs 512 may be generated by, and may interact with, various software modules within the media center 302, e.g., the PVR module 216, the EPG module 218, the web browser 220, the e-mail client 222, the chat client 224, the videophone client 226, the media player/editor 228, etc. For example, in the depicted embodiment, graphical data #1 may be generated by the web browser 220, and the corresponding GUI #1 displayed on TV #1 may include a web browser interface that displays content retrieved from the Internet 108. Similarly, graphical data #2 may be generated by an EPG module 218, and the resulting GUI #2 on TV #2 may include an EPG listing.

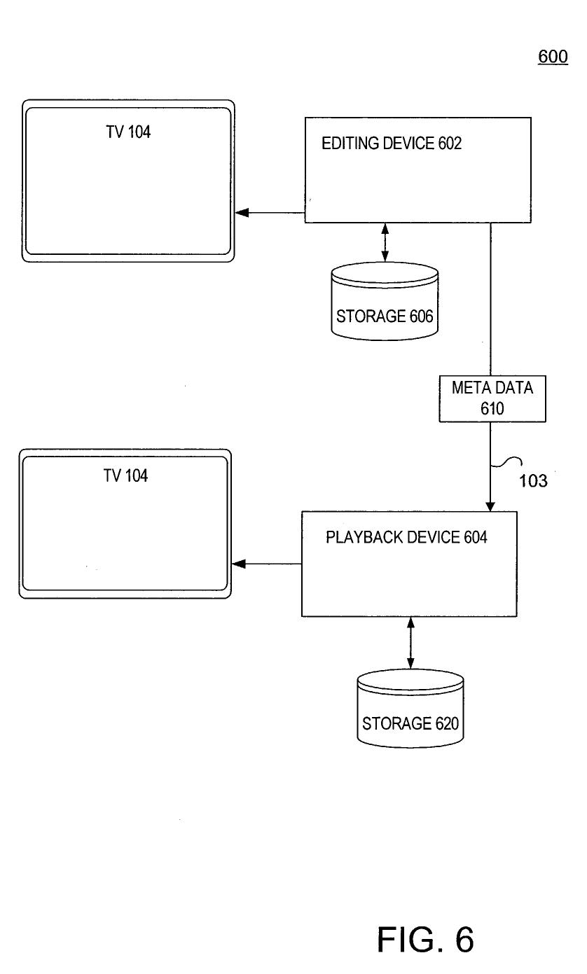

Referring now to FIG. 6, there is shown in a simplified overview a system 600 for distributing customized editions of media programs or other content files, without actually sending them from one location to another. In the depicted embodiment, the system 600 includes an editing device 602 and a playback device 604, either of which may be embodied as an STB 102, a personal computer, a server, a mobile computing device, or the like.

The editing device 602 may be linked to the playback device 604 by a network, such as a broadband network 103, a wireless network, or the Internet 108. As described in greater detail below, the network is used to transmit meta data 610 from the editing device 602 to the playback device 604. The meta data 610, which is generally associated with a specific content file available to the playback device for playback, may comprise several types of information. For example, the meta data 610 can define segments of the content file to skip during playback (e.g., commercial advertisements) or points of interest or highlights within the content file. The meta data 610 can be used by the playback device 604, for example, to skip designated segments or skip to points of interest.

In one embodiment, a copy of a media program is received by the editing device 602. It may be stored in storage 606, e.g., a hard disk drive or any other digital storage system or media. The editing device 602 may be a part of or interact with a personal video recording (PVR) system. The media program may be any type of audio and/or video program, such as a movie, television show, concert, or the like. The media program may be recorded by the editing device 602 or PVR from a broadcast medium (e.g., cable or satellite television), or downloaded from a server, such as a video-on-demand (VoD) server, or it may be delivered manually (e.g., on DVD or other removable medium).

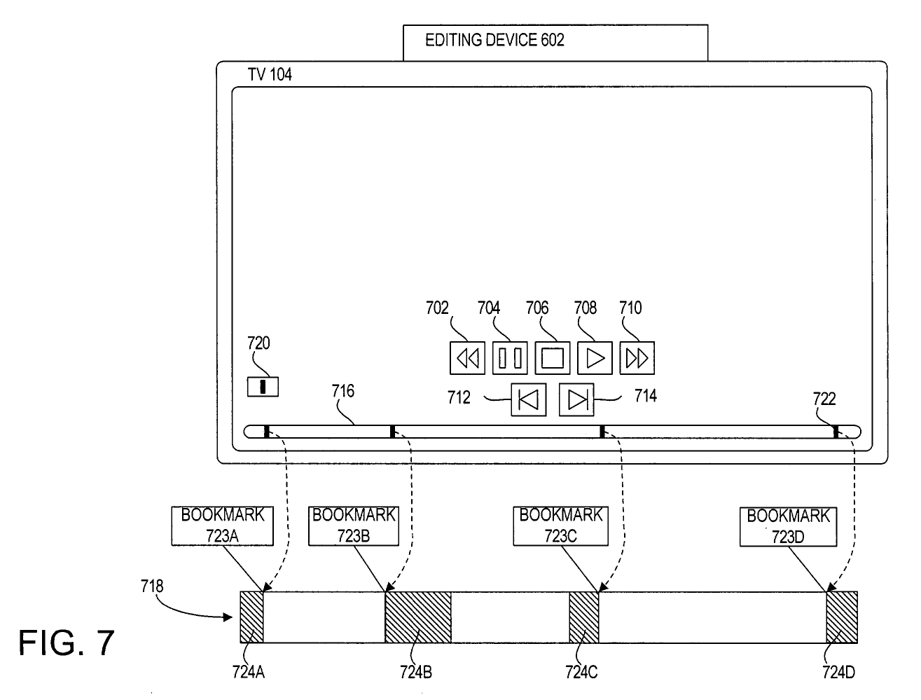

As shown in FIG. 7, the editing device 602 allows a user to designate one or more points of interest or scenes within the media program. A point of interest may correspond to the beginning point of an interesting segment of the program, such as a significant play in a football game. Alternatively, a point of interest may correspond to the end point of a less interesting segment (e.g., an advertisement, an offensive scene, etc. for potential skip-over during playback).

As illustrated, the editing device 602 may provide on-screen controls for assisting the user in designating points of interest. The on-screen controls may include, for instance, a rewind control 702, a pause control 704, a stop control 706, a play control 708, a fast forward control 710, a skip-backward control 712, and a skip-forward control 714. Each of the foregoing controls may be used to navigate playback of the media program until a point of interest is reached. Corresponding physical controls (e.g., buttons) may be included on the remote control 106.

In one configuration, the editing device 602 also provides an on-screen status bar 716, which is a graphical representation of the media program. Each point along the status bar 716 may represent a corresponding point in time within the media program. For clarity of description, FIG. 7 also depicts an abstract representation 718 of the media program.

In one implementation, a user of the editing device 602 navigates to a point of interest within the media program using the on-screen controls (or buttons on the remote control 106). When the point of interest is reached, the user marks the point of interest by activating a marking control or button 720, which may result in a locator 722 being displayed at a corresponding location of the on-screen representation 716 of the media program. An indication of the marked point of interest (a “bookmark”) is stored in the corresponding meta data file as further described later.

In alternative embodiments, a user need not navigate to the position of interest. Rather, the user may “drag and drop” the locator 722 to a desired location on the on-screen representation 716 of the media program, which likewise results in the generation of a corresponding bookmark 723.

In one implementation, multiple sets of bookmarks 723 and/or other meta data 610 may be associated with a single media program. For example, each set of bookmarks 723 may correspond to scenes in which a different actor or actress appears in a particular movie. Data defining the sets of bookmarks can be stored in a single meta data file, or in separate meta data files, each associated with the same media program.

FIG. 7 illustrates the association between meta data 610, e.g., bookmarks 723, and the corresponding media content file, shown conceptually at 718. The meta data 610 is not stored in the content file; rather, it is stored separately so that it can be distributed independently of the media content file. Because the meta data 610 is not stored in the unedited content file, various different meta data 610 can be used with different playback instances of the same content file.

Meta data 610 can comprise a time index, i.e., an indication of a point of time within the media program. For example, a bookmark 723 may include a time index of “00:30:25”, which may indicate a point in time that is 30 minutes and 25 seconds from the beginning of the media program. Alternatively, a bookmark 723 may be embodied as a frame index, offset, chapter reference, scene reference, or other positional indicator within the media program.

In certain embodiments, a bookmark 723 may include a directive to a playback device 604 to skip to a particular time or position within the media program. For example, a bookmark 723 may include a directive to skip backward or forward a fixed period of time (e.g., 132.3 seconds), to skip to a next bookmark, or to start or stop playback. Thus meta data 610 can include not merely location “bookmarks” but various playback instructions. As one example, meta data 610 associated with a program intended for mature audiences might require the playback user to enter a security code or PIN setup by a parent.

Meta data 610 can include additional information, such as commentary by a user of the editing device 602. The additional information may be text, a hyperlink, an image, audio, or video. The commentary may be overlaid on the media program while it is presented at the playback device 604, for example, as pop-up text or a picture-in-picture video commentary.

As depicted in FIG. 7, bookmarks 723 may be used for many different purposes. For example, bookmarks 723b and 756d may mark beginning points of segments of special interest 724b, 724d. Likewise, bookmarks 723a and 756d may mark end points of “skip-over” segments 724a, 724c. A segment of special interest 724b, 724d may include, for instance, highlights from a football game or a significant or entertaining scene from a movie. A skip-over segment 724a, 724c, on the other hand, may include a commercial advertisement from a broadcast television program or an insignificant, boring, or offensive scene. By marking the end of a skip-over segment 724a, 724c, a user of a playback device 604 can rapidly skip past the segment when it is encountered, e.g., when a commercial break begins. The playback system can be set to effect skip-overs, or to skip from one special interest scene to the next, either in response to user input, e.g., via remote control, or automatically. Parental controls can be used to invoke the automatic skip-over mode.

Referring again to FIG. 6, meta data 610, for example indicia of points of special interest or skip-over segments, may be transmitted from the editing device 602 to the playback device 604 via the network 103 or Internet 108. While FIG. 6 illustrates only a single playback device 604, meta data 610 may be sent to multiple devices 604. For example, a user may send the bookmarks 723 to the playback devices 604 of several different friends or family members. Meta data files can be sent in an e-mail message or by various standard protocols, such as HTTP, FTP, or the like.

Transmission of meta data 610 may also occur using wireless transmission techniques, such as infrared (IR) or radio frequency (RF) transmission. Alternatively, meta data 610 can be stored on a removable storage medium at the editing device 602, and then physically transported and copied to or accessed by the playback device 604. Indeed, any method or system for storing, transporting or communicating digital data can be applied to media content meta data 610.

In one embodiment, a copy of the underlying (unedited) media program is also accessed by the playback device 604. For example, the playback device may access a copy of the media program on a DVD or may independently record the media program from a broadcast medium to a local storage device 620.

The received meta data 610 may be used during presentation of the media program by the playback device 604 to present a personalized edition of the media program, e.g., a personalized path through the program. For example, a user may skip to a location defined by a previous or next bookmark among the meta data 610 using a skip-backward or a skip-forward on-screen control 712, 714 or a similar button on a remote control 106. Thus, a user of the playback device 604 may easily skip from one point of interest to another within the media program, watching only the highlights, as defined by the user of the editing device 602. Likewise, a user of the playback device 604 may easily skip segments of lesser interest, such as commercials, where skip-over segments are provided in the meta data 610 created at the editing device 602.

In certain embodiments, multiple bookmarks 723 may be placed in sequential order (e.g., by time or position) by the playback device 604, where such was not already done by the editing device 602. For instance, a user of the editing device 602 may generate the bookmarks 723 in any order. Nevertheless, the editing device 602 and/or the playback device 604 may arrange the bookmarks 723 in sequential order. In an alternative embodiment, a user of the editing device 602 may have intended to create a non-linear or non-chronological path through the media program. In such a case, an indication of the order may be included in the meta data 610, which may be used or ignored by the playback device 604, as desired by the playback user.

The meta data 610 may also be used by the editing device 602, itself, to present a personalized edition of the media program. For instance, the editing device 602 may store sets of bookmarks 723 (e.g., meta data file) corresponding to different media programs stored on a DVD. The user need only supply the correct DVD and load the appropriate set of bookmarks in order to watch the personalized edition. Likewise, multiple sets of bookmarks 723 may be stored in one or more meta data files.

Various other techniques may be used to transmit meta data 610 from an editing device 602 to a playback device 604. One such technique involves essentially embedding meta data 610 within a program interface object (PIO) (not shown). A PIO is an object that includes a plurality of attributes and actions. Actions refers to various operations that may be performed on or in connection with a media program represented by the PIO. For instance, one action may schedule the recording of the program by a PVR. Another action may skip to a time or position indicated by a bookmark during presentation of the media program. Actions may be embodied, for example, as program code in a machine-independent format, such as Java or Javascript.

Attributes contain information about the associated media program. For example, attributes may be used to store the title, starting time, stopping time, running time, actors, etc., associated with the media program. In addition, one or more attributes may be used to store bookmarks. A PIO can include a visual indicator, such as an icon, for display in a graphical user interface (GUI) to facilitate user interaction with the PIO. The GUI may be displayed on an associated television 104 or other display device by the editing device 602 and the playback device 604. A user may interact with the PIO via the visual indicator, and may execute various actions or view attributes by selecting the same from pull-down menus or the like. Thus, bookmarks 723 and other meta data 610 may be encapsulated within a PIO and transmitted from an editing device 602 to a playback device 604.

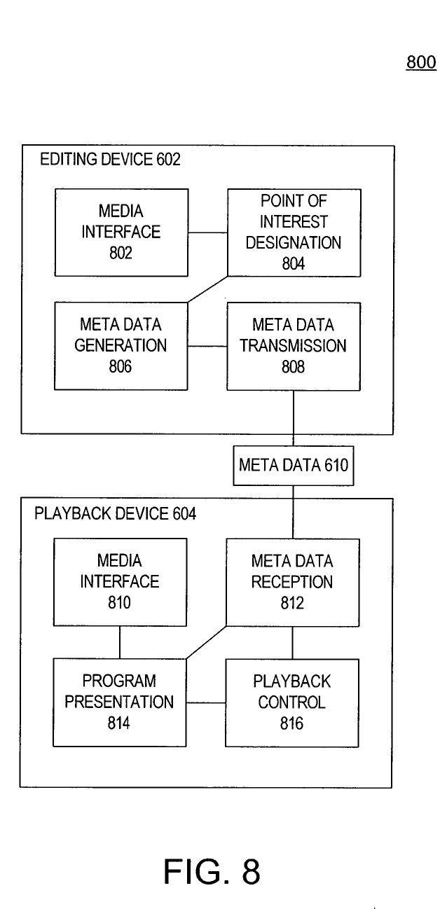

Referring now to FIG. 8, there is shown a block diagram of logical components of a system 800 for distributing personalized editions of media programs by means of meta data 610. More specifically, personalized editions are realized at the playback location through the use of meta data 610, without necessarily transmitting the underlying (unedited) media content. The depicted logical components may be implemented using one or more of the physical components shown in previous figures. Additionally, or in the alternative, various logical components may be implemented as software modules stored in the memory 210 and/or storage device 212 and executed by the CPU 214.

In one implementation, a media interface component 802 of an editing device 602 accesses a media program to be edited. The media interface component 802 may be embodied as a device or software program that accesses a physical storage medium, such as a DVD. Alternatively, the media interface component 802 may be embodied as a PVR configured to record the media program from a broadcast medium. Of course, a wide variety of media interface components 802 may be used within the scope of the invention, depending on the particular type of media in question.

A point of interest designation component 804 may be coupled to the media interface component 802. In one embodiment, the point of interest designation component 804 is employed by a user of the editing device 602 to designate one or more points of interest within the media program, such as game highlights or skip-over segments. The point of interest designation component 804 may designate a point of interest in response to activation of a marking control 720, as explained above. Of course, various other techniques for designating a point of interest may be used within the scope of the invention.

In response to designation of a point of interest, a meta data generation component 806, coupled to the point of interest designation component 804, generates meta data 610 for one or more designated points of interest. As noted, the meta data 610 may include, for instance, a time index, frame index, offset, chapter reference, scene reference, or other positional indicator within the media program. The meta data 610 also typically includes an identifier of the (unedited) media program, e.g., file name, title, channel number/time, VCR Plus code, etc.

Subsequently, a meta data transmission component 808, coupled to the meta data generation component 806, may transmit meta data 610 from the editing device 602 to a playback device 604, as discussed above. The meta data 610 may be transmitted via a network, such as a broadband network 103 or the Internet, using any suitable protocol or technique.

A media interface component 810 of the playback device 604 also accesses a copy of the media program. The media program may be obtained from the same source or a different source as the editing device 602. For instance, both the editing device 602 and the playback device 604 may independently record the media program from a broadcast medium. Alternatively, each of the devices 602, 604 may receive a copy of a DVD including the media program.

A meta data reception component 812 of the playback device 604 receives the transmitted meta data 610 sent (directly or indirectly) from the editing device 602. Thereafter, the media program is presented by a presentation component 814, which is coupled to the meta data reception component 812 and the media interface component 810 (or a storage device 620 containing the subject media program). The presentation component 814 may be embodied as a hardware or software component configured to display the type of media program in question. A wide variety of presentation components 814 may be provided within the scope of the invention.

During presentation of the media program, a user of the playback device 604 may activate on-screen controls, such as a skip-backward control or a skip-forward control 712, 714. Alternatively, the user may employ similar buttons on a remote control 106. In response, a playback control component 816, coupled to the program presentation component 814 and the meta data reception component 812, starts the presentation of the media program at a location defined by a previous or next bookmark 723, depending on which control 712, 714 is activated. Accordingly, a user may skip from one point of interest to another, and can bypass skip-over segments as discussed above (e.g., commercials), employing the meta data 610 to define such points of interest, skip-over segments and the like.

The received meta data 610 can also implement various other informational and control features, as mentioned above, to enhance the playback of the program in a manner largely customized by the user of the editing device 602, which typically will be located remotely from the playback location. In one embodiment, the meta data 610 is created “off-line,” i.e. after the fact, rather than simultaneously during transmission of a broadcast media program.

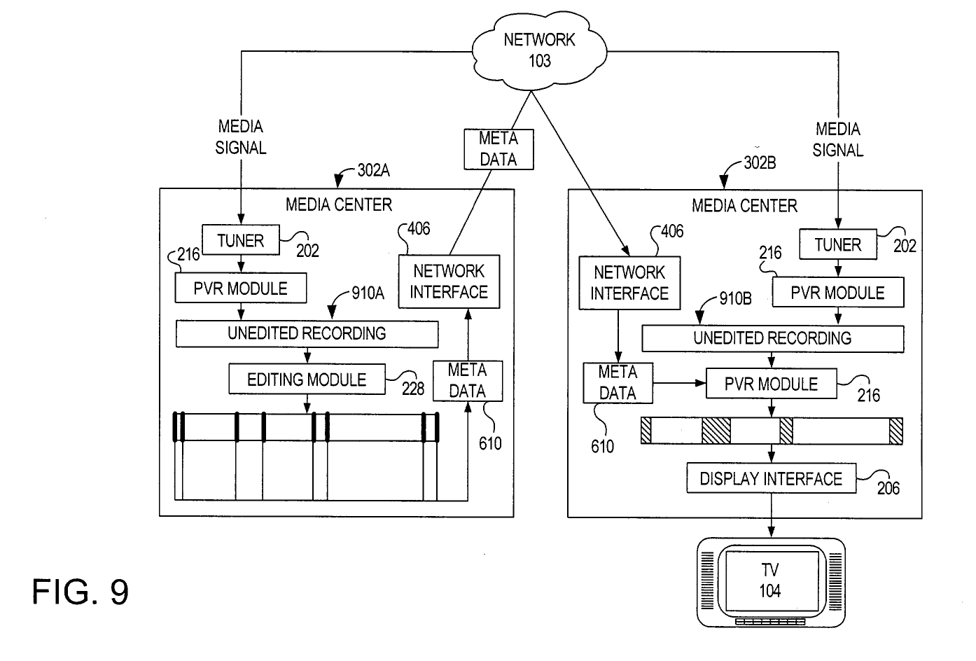

FIG. 9 further illustrates an implementation of the present invention in the context of two media centers 302 communicating with one another. This communication may be implemented in any convenient manner, e.g., e-mail, Internet, or in a decentralized peer-to-peer network. In FIG. 9, media centers 302a and 302b are each configured for receiving media signals from a network 103 using a corresponding tuner 202, which is coupled to a PVR module 216 for recording a media program, as described above. The unedited recording 910a is provided to an media editor 228 which is functionally similar to the editing device 602 described above.

The editor's selection of special interest segments, selection of skip-over segments, identification of the media program, and other information is collected and stored as meta data 610. This meta data 610 can be used later in the same media center 302, or an associated media center extension 304, to customize playback of the recording. The meta data 610 can also be exported via a network interface 406 to the network 103. Although this is illustrated as being the same network 103 from which the unedited recording was received, the meta data 610 can be sent separately over an entirely different network.

The meta data 610 is received via a network interface 406 in a second media center 302b. Media center 302b presumably has already received and stored the unedited recording 910b (another copy), which is essentially the same as the unedited recording 910a, stored in media center 302a, based on which the meta data 610 was created. The meta data 610 received via the network interface 406 is input to a PVR module 216, which also has access to the unedited recording 910b. The meta data 610 is accessed by the PVR module 216 and used to control presentation of the media program via display interface 206 on a television 104.

As mentioned above, the meta data 610 can be shared in this fashion by its author with one or more friends or family members. In fact, the meta data 610 can be shared with an unlimited number of interested users by making it available on a decentralized peer-to-peer network, for example, one that implements the gnutella protocols. The meta data 610 can be freely copied and distributed by its author, without violating copyrights in the corresponding media program, because the meta data 610 does not contain a copy of the underlying program. Further, this system has the benefit of making customized versions of the media program available to multiple consumers, without occupying the bandwidth that would be necessary to distribute copies of the underlying content (and without the risk of copyright infringement). Meta data files of the type described could also be distributed in the absence of a network, for example, using a removable digital storage medium such as a flash memory stick for floppy disks or removable hard drive.

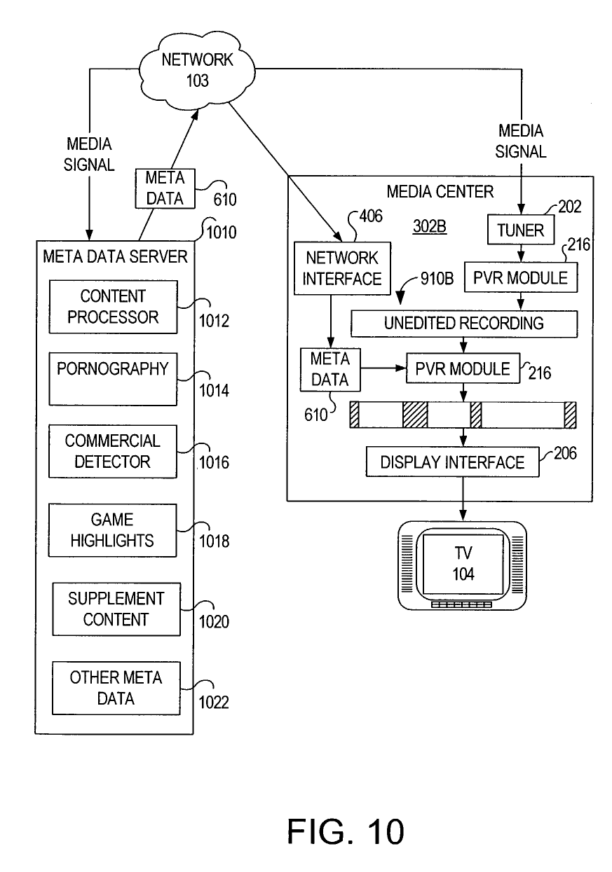

FIG. 10 illustrates a client-server implementation for distributing meta data 610 to multiple subscribers. In FIG. 10, the media signals are again received via network 103 at a media center 302 (or STB) using an appropriate tuner (or plurality of tuners). The meta data server 1010 receives and stores one or more media programs. Through the use of multiple tuners and appropriate hardware known to those skilled in the art, the meta data server 1010 can simultaneously receive a number of separate channels of programming. Suitable data storage (not shown) is provided in the server 1010. (The functionality of the server described here for illustration could also be distributed over multiple servers, either at a single location or geographically dispersed.)

In one embodiment, the meta data server 1010 implements a content processor 1012. Content processing could be done by a human operator or one or more human operators, but may also be automated for consistent quality and in order to accommodate a large volume of programming content. For example, it may be necessary for the server to “edit” several hundred channels of media programs simultaneously.

The content processor (assuming software implementation) can interface with one or more components to provide various functions. By way of illustration, a pornography component 1014 might be used to identify pornographic programs or pornographic segments of programs. While categorizing video content can be challenging, the task is made considerably easier through analysis of the corresponding audio content. The audio content can be converted into text, either through speech recognition techniques, which are well known, or by accessing closed caption channels. The text can then be analyzed to detect pornographic content, using known techniques similar to those that are currently used for analyzing the text of websites. The content of a media program may also be evaluated from provided ratings, e.g., TV-14, TV-M, using techniques known in the art.

The content processor 1012 may also access a commercial detector component 1016 for the purpose of identifying commercial advertising in a given media program. Various systems are known for detecting commercial breaks in television programming. For example, commercial breaks can be detected by lapses in closed captioning (although increasingly commercials are being closed captioned), occurrences of black frames, high rates of scene changes, and discreet messages or triggers identifying a commercial. Commercial detection is discussed in greater detail in, for example, U.S. Pat. No. 5,343,251 to Nafeh. The content processor 1012 may also access a game highlights module 1018. Game highlights might be identified, for example, by detecting “instant replays” in a broadcast.

The content processor 1012 might also incorporate a supplemental content component 1020. This component is used to create and add additional content information. Some examples of supplemental content that can be included in meta data 610 were described previously. Other varieties of meta data 610 can be created for an associated media program. Another example might be indicia useful for digital rights management. Any or all of these kinds of information can be collected into one or more meta data files which are then distributed by the meta data server 1010 via a network 103 to any or all interested users or subscribers. Again, the meta data distribution is not limited to using the same network 103 as that used to distribute the underlying media signals. On the other hand, a broadcaster might choose to append meta data files as described herein to the media signals, although the meta data 610 would not be available at the time of first broadcast, unless the broadcaster made arrangements for processing the media signals in a meta data server 1010 of the type described, prior to the first broadcast.

A meta data server 1010 as described could work during the night, for example, to detect and process all of the commercials on every channel for the previous day, and create meta data 610 accordingly. This activity is conducted “offline,” meaning after the fact; as distinguished from “real-time” processing of media data as received during the broadcast. The following day, any user or client media center could download the meta data 610 for those programs it had recorded the previous day, thereby allowing the user to watch completely commercial-free television the next day. With suitable hardware, buffer memory, etc. one or more meta data servers 1010 can be configured to operate around the clock, so that all of the content broadcast on a given system is processed and meta data 610 made available for distribution in a timely manner.

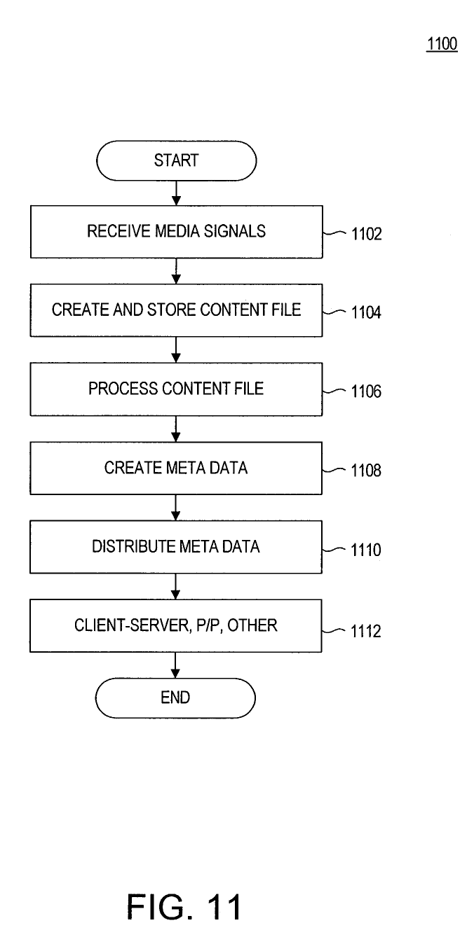

FIG. 11 is a simplified flow diagram 1100 illustrating a methodology in accordance with one aspect of the present invention. This methodology can be implemented in a remote (server or peer) system, or in a local STB, PC, media center or the like. Initially, media signals may be received 1102, typically from a broadcast, network, or machine-readable physical media. The media signals are decoded and/or decompressed as needed for creating 1104 and storing a corresponding content file, for example, a video and/or audio file.

The content file is processed 1106 or “edited” by which the content is examined or analyzed, as described earlier, either by a person or automatically using suitable software. This processing typically does not alter the content file itself; rather, meta data 610 identifying, for example, highlight scenes or commercial breaks, is created. Thus meta data 610 is created 1108 as a product of processing the content file. Multiple processing steps can be effected resulting in different respective meta data files for the same content file, if desired. For example, one meta data file could be created to enable commercial-free playback of the corresponding content file. Another meta data file might be created to enable playback of a sanitized version of the same content file, by skipping over sexually explicit scenes.

Finally, the meta data file(s) are released for distribution 1110. Distribution can be by any means, as described earlier, including so-called push or pull protocols 1112. They could simply be posted on a website or ftp site, etc. Optionally, meta data 610 can be shared by storing it in a public or “shared” peer-to-peer network file.

While specific embodiments and applications of the present invention have been illustrated and described, it is to be understood that the invention is not limited to the precise configuration and components disclosed herein. Various modifications, changes, and variations apparent to those skilled in the art may be made in the arrangement, operation, and details of the methods and systems of the present invention disclosed herein without departing from the spirit and scope of the invention.

1. A method in an entertainment system for controlling presentation of a media content file, the method comprising:
accessing an unedited copy of the media content file;
accessing through a network a set of meta data associated with the media content file; and
presenting the media content file in accordance with the meta data.

2. The method of claim 1, wherein presenting comprises skipping over at least one portion of the media content file as designated in the meta data.

3. The method of claim 2, wherein the media content file comprises television programming.

4. The method of claim 3, wherein the skipped-over portion comprises a commercial advertisement.

5. The method of claim 3, wherein the skipped-over portion comprises a scene deemed unsuitable for young audiences.

6. The method of claim 1, wherein presenting comprises skipping to a selected location within the media content file as designated in the meta data.

7. The method of claim 6, wherein the selected location is the beginning of a scene of special interest.

8. The method of claim 7, wherein the selected scene of special interest comprises a highlight of a sports event.

9. The method of claim 6, wherein the selected location is the end of a scene of lesser interest.

10. The method of claim 2, wherein said skipping is triggered manually.

11. The method of claim 2, wherein said skipping proceeds automatically during presentation of the media content file.

12. The method of claim 2, wherein the meta data indicates a starting location and a duration of the skipped-over segment.

13. The method of claim 2, wherein the meta data indicates a starting location and an ending location of the skipped-over segment.

14. The method of claim 1, wherein accessing through a network comprises receiving the meta data through the Internet.

15. The method of claim 1, wherein accessing through a network comprises receiving the meta data from a meta data server.

16. The method of claim 1, wherein accessing through a network comprises receiving the meta data via a decentralized peer-to-peer network.

17. The method of claim 16, further comprising sharing meta data with peers via a decentralized peer-to-peer network, thereby enabling the peers to present copies of the media content file in accordance with the meta data

18. The method of claim 1, wherein the entertainment system comprises a set top box for accessing the unedited copy of the media content file.

19. The method of claim 14, wherein the entertainment system comprises a media center for accessing the unedited copy of the media content file.

20. An entertainment system for receiving and processing broadcast media signals comprising:
at least one tuner to receive broadcast media signals;
a memory to store an unedited media program derived from the received broadcast media signals;
an interface to receive meta data associated with the unedited media program; and
a processor to control a playback presentation of the unedited media program responsive to the received meta data.

21. The entertainment system of claim 20, wherein the interface for receiving meta data comprises a network interface.

22. The entertainment system of claim 20, wherein the interface for receiving meta data comprises a web browser.

23. The entertainment system of claim 20, wherein the interface for receiving meta data comprises an e-mail client.

24. The entertainment system of claim 20, wherein the interface for receiving meta data comprises a peer-to-peer network client.

25. The entertainment system of claim 20, wherein the interface for receiving meta data comprises a removable memory interface.

26. The entertainment system of claim 20, wherein the processor is to skip over at least one portion of the media content file as designated in the meta data.

27. The entertainment system of claim 26, wherein the media content file comprises television programming.

28. The entertainment system of claim 27, wherein the skipped-over portion comprises a commercial advertisement.

29. The entertainment system of claim 27, wherein the skipped-over portion comprises a scene deemed unsuitable for young audiences.

30. The entertainment system of claim 20, wherein the processor is to skip to a selected location within the media content file as designated in the meta data.

31. A playback apparatus comprising:
a media interface to receive broadcast media signals;
a meta data interface to receive a set of meta data associated with an unedited media program; and
a playback control component to control a playback presentation of the unedited media program responsive to the received meta data.

32. The playback apparatus of claim 31, wherein the meta data interface comprises a web browser.

33. The playback apparatus of claim 31, wherein the meta data interface comprises an e-mail client.

34. The playback apparatus of claim 31, wherein the meta data interface comprises a peer-to-peer network client.

35. The playback apparatus of claim 31, wherein the meta data interface comprises a removable memory interface.

36. The playback apparatus of claim 31, wherein the playback control component is to skip over at least one portion of the media content file as designated in the meta data.

37. The playback apparatus of claim 36, wherein the media content file comprises television programming.

38. The playback apparatus of claim 37, wherein the skipped-over portion comprises a commercial advertisement.

39. The playback apparatus of claim 37, wherein the skipped-over portion comprises a scene deemed unsuitable for young audiences.

40. The playback apparatus of claim 31, wherein the playback control component is to skip to a selected location within the media content file as designated in the meta data.

41. A meta data server for distributing meta data to customize playback of media content comprising:
a receiver to receive broadcast media signals and convert the media signals into corresponding media content;
a content processor to analyze the media content, the content processor including an editing module for selecting locations within the media content and recording indicia of the selected locations as meta data; and
an interface for exporting the meta data via a network to remote users for the users to customize playback of the media content.

42. The meta data server of claim 41, wherein the receiver includes at least one tuner for receiving television signals, the media content comprising television programming.

43. The meta data server of claim 42, wherein the content processor has access to a module for detecting commercial advertisements in the television programming, thereby enabling the editing module to select locations within the media content that correspond to detected commercial advertisements.

44. The meta data server of claim 42, wherein the content processor has access to a module for detecting highlights in the television programming, thereby enabling the editing module to select locations within the media content that correspond to detected highlights.

45. The meta data server of claim 42, wherein the content processor has access to a module for detecting pornography in the television programming, thereby enabling the editing module to select locations within the media content that correspond to detected pornography.

46. The meta data server of claim 41, wherein the interface for exporting the meta data comprises a web site.

47. The meta data server of claim 41, wherein the interface for exporting the meta data comprises a peer-to-peer client.

48. The meta data server of claim 41, wherein the interface for exporting the meta data comprises a removable storage medium.

49. The meta data server of claim 41, wherein the interface for exporting the meta data comprises an e-mail server.

50. The meta data server of claim 41, wherein the selected locations within the media content comprise the beginnings of commercial advertisements.

51. The meta data server of claim 41, wherein the selected locations within the media content comprise the beginnings of scenes of special interest.

52. A machine-readable medium encoded with data for customizing playback of media content, the encoded data comprising:
an identifier of an associated unedited media content file; and
meta data for customizing playback of the associated unedited media content file.

53. The machine-readable medium of claim 52, wherein the meta data includes at least one designation of a scene to skip over within the associated media content file.

54. The machine-readable medium of claim 52, wherein the meta data includes at least one designation of a location of a commercial advertisement within the associated media content file.

55. The machine-readable medium of claim 52, wherein the meta data includes at least one designation of a highlight scene within the associated media content file.

56. The machine-readable medium of claim 52, wherein the meta data includes at least two different sets of meta data both associated with the identified unedited media content file, thereby enabling at least two different presentations of the same unedited media content file.
